(19) United States
(12) Patent Application Publication
(10) Pub. No.: US 2017/0190956 A1
(43) Pub. Date: Jul. 6, 2017

(54) AQUEOUS EMULSIONS FOR CROSSLINKING

(71) Applicant: KMP Holdings, LLC, Wichita, KS (US)

(72) Inventors: Sean Beach, Duncan, OK (US); Derek Mouton, Youngsville, LA (US); Guy McClung, Spring, TX (US)

(73) Assignee: KMP Holdings, LLC, Wichita, KS (US)

(21) Appl. No.: 15/117,122

(22) PCT Filed: Feb. 12, 2015
(86) PCT No.: PCT/US2015/015574

§ 371 Date: Aug. 5, 2016

Related U.S. Application Data
(60) Provisional application No. 61/939,612, filed on Feb. 13, 2014.

(51) Int. Cl. C09K 8/68; C09K 8/84; C09K 8/28; C09K 8/88; B01F 17/00; C09K 8/90

(52) U.S. Cl. CPC C09K 8/685; B01F 17/0085; C09K 8/68; C09K 8/90; C09K 8/28; C09K 8/887; C09K 8/84

(57) ABSTRACT

Aqueous emulsions containing a crosslinking agent, an emulsifying agent, a vegetable oil, and optionally a freeze point depressing agent are provided. Also provided are fluids that include the aqueous emulsion and a crosslinkable organic polymer, and additional fluids that contain the aqueous emulsion, a crosslinkable organic polymer and a proppant. The aqueous emulsions and fluids are useful in a variety of oil field and gas field applications. Furthermore, methods for the recovery of petroleum using the fluids described herein are also provided.

### CROSS-REFERENCE TO RELATED APPLICATIONS

This application claims benefit of U.S. Provisional Application No. 61/939,612, filed Feb. 13, 2014, which is hereby incorporated herein by reference in its entirety.

### TECHNICAL FIELD

This application relates generally to aqueous emulsions for crosslinking, fluids prepared using these aqueous emulsions, and methods of using thereof.

### BACKGROUND

The ability to control the viscosity of fluids during drilling operations is important to the recovery of oil and gas. For example, during hydraulic fracturing, maintaining optimal fluid viscosity is important for creating fractures and increasing fracture width and length. Crosslinkable polymers and crosslinking agents can be added to fluids in order to increase their viscosity. Typically, the base carrier fluid for crosslinkers are petroleum- and clay-based blends or emulsions. There is a need for fluids for use in various drilling operations that are formulated from environmentally acceptable materials.

### SUMMARY

Provided herein are aqueous emulsions that comprise a crosslinking agent, an emulsifying agent, and a vegetable oil.

The crosslinking agent can be, for example, a boron crosslinking agent, a zirconium crosslinking agent, a titanium crosslinking agent, an aluminum crosslinking agent, or a combination thereof. In some embodiments, the crosslinking agent can comprises a boron crosslinking agent. For examples, the boron crosslinking agent can comprise ulexite, colemanite, boracite, or a combination thereof. In certain embodiments, the boron crosslinking agent can comprise ulexite. In some embodiments, the aqueous emulsion can comprise from 20% by weight to 60% by weight crosslinking agent (e.g., from 30% by weight to 50% by weight crosslinking agent), based on the total weight of the aqueous emulsion.

The emulsifying agent can comprise, for example, a surfactant. The surfactant can comprise an amphoteric surfactant, an anionic surfactant, a cationic surfactant, a nonionic surfactant, a zwitterionic surfactant, or a combination thereof. In some embodiments, the surfactant can comprise an anionic surfactant (e.g., an alkylbenzenesulfonate surfactant). In some embodiments, the surfactant can comprise a nonionic surfactant (e.g., an ethoxylated alcohol surfactant). In certain embodiments, the emulsifying agent can comprise a blend of two or more surfactants (e.g., a blend of two or more nonionic surfactants, a blend of two or more anionic surfactants, or a blend of one or more anionic surfactants and one or more nonionic surfactants). In some embodiments, the aqueous emulsion can comprise from greater than 0% by weight to 10% by weight emulsifying agent (e.g., from greater than 0% by weight to 5% by weight emulsifying agent), based on the total weight of the aqueous emulsion.

The vegetable oil can comprises a non-hydrogenated vegetable oil, such as canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil, tea tree oil, or a combination thereof. In some cases, the non-hydrogenated vegetable oil can comprise a high oleic oil. In certain embodiments, the vegetable oil can comprise canola oil. In certain embodiments, the vegetable oil can comprise castor oil. In some embodiments, the aqueous emulsion can comprise from 10% by weight to 40% by weight vegetable oil (e.g., from 20% by weight to 30% by weight vegetable oil), based on the total weight of the aqueous emulsion.

Optionally, the aqueous emulsion can further comprise a freeze point depressing agent. The freeze point depressing agent can comprise a salt (e.g., sodium chloride, calcium chloride, or a formate salt such as sodium formate). The freeze point depressing agent can comprise an alcohol, such as methanol, ethanol, isopropanol, ethylene glycol, propylene glycol, glycerol, or a combination thereof. In certain embodiments, the freeze point depressing agent can comprise propylene glycol. In certain embodiments, the freeze point depressing agent can comprise ethylene glycol. In some embodiments, the aqueous emulsion can comprise from 5% by weight to 30% by weight freeze point depressing agent (e.g., from 5% by weight to 20% by weight freeze point depressing agent, or from 10% by weight to 15% by weight freeze point depressing agent), based on the total weight of the aqueous emulsion.

In some embodiments, the aqueous emulsion can comprise 20% by weight to 60% by weight crosslinking agent; 10% by weight to 40% by weight vegetable oil; 10% by weight to 40% by weight water; greater than 0% by weight to 10% by weight emulsifying agent; and optionally 5% by weight to 30% by weight freeze point depressing agent. In certain embodiments, the aqueous emulsion can comprise 30% by weight to 50% by weight crosslinking agent; 20% by weight to 30% by weight vegetable oil; 15% by weight to 30% by weight water; greater than 0% by weight to 5% by weight emulsifying agent; and optionally 10% by weight to 15% by weight freeze point depressing agent.

In some embodiments, the aqueous emulsion can comprise less than 5% by weight of a petroleum distillate, based on the total weight of the aqueous emulsion. In some embodiments, the aqueous emulsion can be substantially free of petroleum distillates (e.g., the aqueous emulsion can include less than 0.5% by weight petroleum distillates, based on the total weight of the aqueous emulsion).

In some embodiments, the aqueous emulsion can comprise less than 5% by weight of a clay, based on the total weight of the aqueous emulsion. In some embodiments, the aqueous emulsion can be substantially free of clays (e.g., the aqueous emulsion can include less than 0.5% by weight clays, based on the total weight of the aqueous emulsion).

Also provided are fluids that comprise a crosslinkable organic polymer, a crosslinking agent, an emulsifying agent, a vegetable oil, and water.

The crosslinkable organic polymer can comprise a crosslinkable polysaccharide, such as galactomannan, cellulose, or a combination thereof. In some embodiments, the crosslinkable organic polymer can comprise cellulose (e.g., carboxymethylcellulose, hydroxymethylcellulose, polyanionic cellulose, or combinations thereof). In some embodiments, the crosslinkable organic polymer can comprise galactomannan (e.g., guar, such as natural guar, a guar derivative, or a combination thereof).

The crosslinking agent can be, for example, a boron crosslinking agent, a zirconium crosslinking agent, a titanium crosslinking agent, an aluminum crosslinking agent, or a combination thereof. In some embodiments, the crosslinking agent can comprises a boron crosslinking agent. For examples, the boron crosslinking agent can comprise ulexite, colemanite, boracite, or a combination thereof. In certain embodiments, the boron crosslinking agent can comprise ulexite.

The emulsifying agent can comprise, for example, a surfactant. The surfactant can comprise an amphoteric surfactant, an anionic surfactant, a cationic surfactant, a nonionic surfactant, a zwitterionic surfactant, or a combination thereof. In some embodiments, the surfactant can comprise an anionic surfactant (e.g., an alkylbenzenesulfonate surfactant). In some embodiments, the surfactant can comprise a nonionic surfactant (e.g., an ethoxylated alcohol surfactant). In certain embodiments, the emulsifying agent can comprise a blend of two or more surfactants (e.g., a blend of two or more nonionic surfactants, a blend of two or more anionic surfactants, or a blend of one or more anionic surfactants and one or more nonionic surfactants).

The vegetable oil can comprises a non-hydrogenated vegetable oil, such as canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil, tea tree oil, or a combination thereof. In some cases, the non-hydrogenated vegetable oil can comprise a high oleic oil. In certain embodiments, the vegetable oil can comprise canola oil. In certain embodiments, the vegetable oil can comprise castor oil.

Optionally, the fluid can further comprise a freeze point depressing agent. The freeze point depressing agent can comprise a salt (e.g., sodium chloride, calcium chloride, or a formate salt such as sodium formate). The freeze point depressing agent can comprise an alcohol, such as methanol, ethanol, isopropanol, ethylene glycol, propylene glycol, glycerol, or a combination thereof. In certain embodiments, the freeze point depressing agent can comprise propylene glycol. In certain embodiments, the freeze point depressing agent can comprise ethylene glycol.

Optionally, the fluid can further comprise one or more additives (e.g., a biocide, a stabilizer, a breaker, a corrosion inhibitor, a scale inhibitor, a proppant, a friction reducer, a lubricant, a gel stabilizer, a viscosifier, a emulsifier, a fluid loss control additive, a pH control agent, a surfactant, or a combination thereof).

In some embodiments, the fluid can further comprise a biocide (e.g., a biocide selected from the group consisting of gluteraldehyde, quaternary ammonium chloride, tetrakis hydromethylphosphonium sulfate, tributyl tetradecyl phosphonium chloride, 2-bromo-2-nitro-3-propanediol, 2-bromo-2-nitro-1,3-propanediol, 2,2-dibromo-3-nitrilopropionamide, 2-monobromo-3-nitrilopropionamide, 2-(thiocyanomethylthio) benzothiazole, 5-chloro-2-methyl-4-isothizolin-3-one, dazomet, dodecyl dimethyl ammonium chloride, magnesium chloride, magnesium nitrate, methyl tert-butyl ether, methyl-4-isothiazolin, phenanthrene, sodium dichloro-s-triazinetrione, derivatives thereof, and combinations thereof).

In some embodiments, the fluid can further comprise a stabilizer (e.g., a stabilizer selected from the group consisting of choline chloride, tetramethyl ammonium chloride, potassium chloride, sodium chloride, derivatives thereof, and combinations thereof).

In some embodiments, the fluid can further comprise a breaker (e.g., a breaker selected from the group consisting of ammonium persulfate, diammonium peroxidisulfate, calcium chloride, sodium chloride, sodium chloride, sodium bromate, N,N-dimethylformamide, magnesium peroxide, magnesium oxide, chlorous acid, ethylene glycol, copper compounds, derivatives thereof, and combinations thereof).

In some embodiments, the fluid can further comprise a corrosion inhibitor (e.g., a corrosion inhibitor selected from the group consisting of isopropanol, methanol, formic acid, acetaldehyde, aldehyde, quaternary ammonium salts, N,N-dimethylformamide, ammonium bisulfate, derivatives thereof, and combinations thereof).

In some embodiments, the fluid can further comprise a scale inhibitor (e.g., a scale inhibitor selected from the group consisting of polyacrylamide, acrylamide copolymer, sodium acrylate, sodium polycarboxylate, ethylene glycol, methylene phosphoric acid, phosphonic acid salts, derivatives thereof, and combinations thereof).

In some embodiments, the fluid can further comprise a friction reducer (e.g., a friction reducer selected from the group consisting of ammonium sulfate, anionic surfactants, polyacrylamide, anionic polymer, cationic polymer, petroleum distillate, hydrotreated light petroleum distillate, methanol, ethylene glycol, derivatives thereof and a combination thereof).

In certain embodiments, the fluid can further comprise a proppant. In some cases, the proppant can be selected from the group consisting of silica, quartz sand, resin-coated sand, glass beads, ceramic beads, walnut shell fragments, aluminum pellets, nylon pellets, organic particles, synthetic particles, glass microspheres, sintered bauxite, aluminum silicate, calcium oxide, iron oxide, kyanite, mullite, phenolic resin, diatomaceous earth, styrene, polystyrene, titanium dioxide, and combinations thereof. In some embodiments, the fluid can comprise less than 5% by weight of a petroleum distillate, based on the total weight of the fluid. In some embodiments, the fluid can be substantially free of petroleum distillates (e.g., the fluid can include less than 0.5% by weight petroleum distillates, based on the total weight of the fluid).

In some embodiments, the aqueous emulsion can comprise less than 5% by weight of a clay, based on the total weight of the aqueous emulsion. In some embodiments, the aqueous emulsion can be substantially free of clays (e.g., the aqueous emulsion can include less than 0.5% by weight clays, based on the total weight of the aqueous emulsion).

Also provided are methods of recovering petroleum from a petroleum reservoir. The method can include pumping a fluid described herein into a petroleum reservoir and hydraulically fracturing the petroleum reservoir using the hydraulic fracturing fluid, thereby recovering petroleum from the petroleum reservoir. In some embodiments, the method can also include drilling a wellbore to the petroleum reservoir before the step of hydraulically fracturing. In some instances, hydraulic fracturing can comprise introducing fractures into a subterranean formation penetrated by the wellbore.

### DESCRIPTION OF DRAWINGS

FIG. 1 shows the crosslinking viscosity performance of the vegetable based ulexite delayed crosslinker with a guar slurry at about 180° F.

FIG. 2 shows another example of the crosslinking viscosity performance of the vegetable based ulexite delayed crosslinker with a guar slurry at about 180° F. using a chemical breaker breaker (ammounium persulfate (GB 701) or encapsulated ammonium persulfate (GB 710E)).

### DETAILED DESCRIPTION

Provided herein are aqueous emulsions containing a crosslinking agent, an emulsifying agent, a vegetable oil, and optionally, a freeze point depressing agent. Also provided are fluids that include the aqueous emulsion and a crosslinkable organic polymer, and additional fluids that contain the aqueous emulsion, a crosslinkable organic polymer and a proppant. Furthermore, methods for the recovery of petroleum by using the fluids containing the aqueous emulsion and a crosslinkable organic polymer are provided.

The vegetable oil-based formulations described herein can offer advantages over existing commercially available alternatives. For example, the formulations can be substantially free from classical suspending agents (e.g., clay and silica) as well as petroleum distillates. The formulations can also be washed from equipment with water, eliminating the need to rinse equipment and lines with an organic solvent such as diesel or mineral oil. As a result, the formulations can be more environmentally friendly than existing commercially available alternatives.

### Definitions

As used herein, the following terms have the meanings ascribed to them unless specified otherwise.

The term “aqueous emulsion” refers to a dispersion of one immiscible liquid into another, wherein one liquid is water. For example, in a water-in-oil emulsion, the water forms the dispersed (e.g., discontinuous) phase, and the oil is the dispersion (e.g., continuous) medium. Likewise, in an oil-in-water emulsion, the oil forms the dispersed (e.g., discontinuous) phase, and the water is the dispersion (e.g., continuous) medium.

The term “crosslinking agent” or “crosslinker” refers to a chemical agent, compound or substance capable of crosslinking an organic polymer to form a viscous crosslinked organic polymer (e.g., a gel).

The term “emulsifying agent” or “emulsifier” refers to a chemical agent, compound, or substance capable of producing an emulsion by reducing the interfacial tension between the two insoluble liquids.

The terms “boron containing crosslinking agent,” “boron containing crosslinker,” “boron crosslinking agent,” and “boron crosslinker” refer to a chemical agent, compound, or substance that contains boron, boron ion or is a derivative of boric acid and is capable of crosslinking an organic polymer to form a viscous crosslinked organic polymer.

The terms “zirconium containing crosslinking agent,” “zirconium containing crosslinker,” “zirconium crosslinking agent,” and “zirconium crosslinker” refer to a chemical agent, compound, or substance that contains zirconium, zirconium ion, zirconate, or is a derivative of zirconium, and is capable of crosslinking an organic polymer to form a viscous crosslinked organic polymer.

The terms “titanium containing crosslinking agent,” “titanium containing crosslinker,” “titanium crosslinking agent,” and “titanium crosslinker” refer to a chemical agent, compound, or substance that contains titanium, titanium ion, titanate, or is a derivative of titanium and is capable of crosslinking an organic polymer to form a viscous crosslinked organic polymer.

The terms “aluminum containing crosslinking agent,” “aluminum containing crosslinker,” “aluminum crosslinking agent,” and “aluminum crosslinker” refer to a chemical agent, compound, or substance that contains aluminum, aluminum ion, aluminate, or is a derivative of aluminum and is capable of crosslinking an organic polymer to form a viscous crosslinked organic polymer.

The term “vegetable oil” or “vegetable based oil” is an oil composed of triglycerides extracted from a plant, such as from the seeds of a plant.

The term “freeze point depressing agent” refers to a chemical agent, compound, or substance that can depress (decrease) the freezing point of a liquid when the agent is mixed with the liquid.

The term “surfactant” refers to a soluble or partially soluble chemical compound that reduces the surface tension of liquids, or reduces interfacial tension between two liquids, or a liquid and a solid by congregating and orienting itself at these interfaces.

The term “nonionic surfactant” refers to a type of surfactant (e.g., a chemical that can reduce the surface tension of a liquid) with a non-charged hydrophilic portion. Typically, a nonionic surfactant is a chemical that is partly hydrophobic (e.g., lipophilic) and partly hydrophilic.

The term “alcohol” refers to a chemical compound composed of a hydroxyl group bound to a carbon atom.

The term “galactomannan” refers to a polysaccharide having a mannose backbone and galactose side groups, e.g., a (1-4) linked β-D-mannopyranose backbone with attached (1→6) linked to D-galactopyranosyl units including polysaccharides derived from the endosperms of seeds from plants such as tam, huisache, locust bean, palo verde, flame tree, guar bean plant, honey locust, lucerne, Kentucky coffee bean, Japanese pagoda tree, indigo, jenna, rattlehox, clover, fenergruk seeds, soy bean hulls and the like. The mannose to galactose ratio can be about 2 to 1.

The terms “guar” and “guar gum” are used according to their plain, ordinary meaning, and refer to substances containing galactomannan or known derivatives thereof (e.g. natural derivatives). Non-limiting examples of guar include natural guar (e.g., naturally occurring guar), natural guar derivatives, and non-naturally occurring guar derivatives. Examples of guar derivatives include, but are not limited to, hydroxyethyl guar, hydropropyl guar, carboxymethyl guar, carboxymethyl hydropropyl guar, carboxyalkylhydroxy guar, carboxyalkylhydroxyalkyl guar, guar hydroxyalkyltriammonium chloride, cationic functional guars, hydrophobically modified guars, other modified guars, and other derivatives thereof.

“Polyanionic cellulose” is a cellulose ether made from natural cellulose. It can have varied chemical substitution (e.g., carboxymethyl substitutions).

The term “hydraulic fracturing fluid” refers to an oil- or water-based fluid that can be used to generate and/or maintain subterranean fractures. Fracturing fluids are used to create a fracture of an adequate width and length and alternatively, to transport proppants into a fracture.

The term “slurry” refers to a fluid mixture of substantially insoluble solid particles and a liquid that retains fluidity.

The term “biocide” refers to a chemical agent, compound, or substance that inhibits the growth of microorganisms, such as aerobic bacteria, anaerobic bacteria, slide-formaing bacteria, sulfate reducing bacteria and algae. Biocides include, but are not limited to, bactericides, algaecides, and microbicides.

The term “stabilizer” refers to a chemical agent, compound, or substance that is used to keep a fluid at a desired viscosity at high temperatures.

The term “breaker” refers to a chemical, compound, or substance that is used to break the polymers (e.g., galactomannan, underivatized guar and derivatized guar) and crosslink sites at low temperatures.

The term “corrosion inhibitor” refers to a chemical agent, compound, or substance that protects metal (e.g., iron and steel) components from corrisive fluid. For example, in hydraulic fracturing, the corrosion inhibitor protects the metal of the wellbore and other fracturing and drilling equipment.

The term “scale inhibitor” refers to a chemical agent, compound, or substance that is used to minimize or prevent scale (e.g., mineral salt deposits, calcium carbonate, calcium sulfate, barium sulfate, strontium sulfate, iron sulfide, iron oxides, iron carbonate, silicates, phosphates, and oxides) deposition in the fracturing system. One of skill in the art recognizes that scale can be any of a number of compounds that are insoluble or slightly soluble in water.

The term “proppant” refers to an agent, compound, or substance that is used to hold open a fracture or crack in the formation. For example, a proppant can be a material for propping open (e.g., holding open) fractures to allow oil or gas to flow from a well or petroleum reservoir.

The terms “friction reducer” and “lubricant” refer a chemica agent, compound or substance that is used to reduce friction (e.g., rotary friction, axial friction, etc.) between tools (e.g., casing, drill, tubing, drill bit bearings, etc.) in the wellbore.

The term “viscosifier” refers to a chemical agent, compound or substance that can increase the viscosity of a fluid used in the recovery of hydrocarbons from a subterranean formation. A viscosifier can be used to increase the viscosity of a water-based fluid or mud, an oil-based fluid or mud, synthetic based fluid or mud, or a brine.

The term “fluid loss control additive” refers to to a chemical agent, compound or substance that is used to minimize fracturing or drilling fluid leak-off into the formation permeability fractures. A fluid loss control additive can used to maintain the viscosity, rheology, and compressive strength of a fracturing or drilling fluid.

The term “pH control agent” refers to a chemical agent, compound or substance that is used to adjust the pH of a fluid. Examples of pH control agents include, but are not limited to, any acid or any base that is known in the art.

The term “hydraulic fracturing” refers to the process and methods of breaking down a geological formation, i.e., the rock formation around a wellbore, by pumping fluid at very high pressures, in order to increase production rates from a hydrocarbon reservoir.

The term “drill” includes machines used to crush or cut rock useful, for example, in processes to recover petroleum from petroleum wells. Drills may be used in boring holes in natural or synthetic plugs used in hydraulic fracturing processes and forming boreholes to be lined with casing. The term “subterranean drill” refers to a drilling tool that crushes or cuts rocks located under the surface of the earth.

The term “petroleum reservoir” refers to a body of earth (e.g., rock) containing petroleum and located underground (e.g., under the surface of the earth or subterranean).

It should be noted that, as used in this specification and the appended claims, the singular forms “a”, “an” and “the” include plural referents unless the content clearly dictates otherwise. Thus, for example, reference to “an oil” can include a mixture of two or more such agents, and the like

Aqueous Emulsions

The aqueous emulsion provided herein can include a crosslinking agent, an emulsifying agent, and a vegetable oil. The emulsion can be a water-in-oil emulsion (e.g., emulsion can include water droplets dispersed in the vegetable oil).

The crosslinking agent can be a boron crosslinking agent, a zirconium crosslinking agent, a titanium crosslinking agent, an aluminum crosslinking agent, a mixed metal crosslinking agent, or a combination thereof. For example, the crosslinking agent can include a boron compound, such as boric acid, borates (e.g., disodium octaborate tetrahydrate, sodium diborate and pentaborates), naturally occurring borate minerals, and synthetic borate minerals; a zirconium compound, such as naturally occurring zirconate minerals and synthetic zirconate minerals (e.g., zirconium lactate, zirconium lactate triethanolamine, zirconium carbonate, zirconium acetylacetonate and zirconium diisopropylamine lactate); a titanium compound, such as naturally occurring titanate minerals and synthetic titanate minerals (e.g., titanium ammonium lactate, titanium triethanolamine, and titanium acetylacetonate); an aluminium compound, such as naturally occurring aluminate minerals and synthetic minerals (e.g., aluminum lactate or aluminum citrate); or mixed metal compounds.

Examples of suitable borates include, but are not limited to, colemanite, ulexite, nobleite, gowerite, frolovite, meyerhofferite, inyoite, priceite, tertschite, ginorite, pinnoite, patemoite, kurnakovite, inderite, probertite, preobazhinskite, hydroboracite, inderborite, howlite, hydroboracite, kaliborite, kernite, kumakovite, pandermite, tincalconite, tunellite, veatchite, any Class V-26 borates according to the Dana classification system, hydrated borates containing hydroxyl or halogen, as described in Gaines, R. V., et al., Dana's New Mineralogy, John Wiley & Sons, Inc., NY, (1997), and the class V/G, V/H, V/J or V/K borates according to the Strunz classification system as described in Hugo Strunz; Ernest Nickel: Strunz Mineralogical Tables, Ninth Edition, Stuttgart: Schweizerbart, (2001)).

In some embodiments, the borate can comprise three or more boron atoms per molecule. For example, the borate can be a triborate, tetraborate, pentaborate, hexaborate, pentaborate, octaborate, decaborate, etc. The boron crosslinking agent can include at least one component that is a boron metal ion.

In some embodiments, the boron crosslinking agent can be ulexite, colemanite or boracite. In certain embodiments, the boron crosslinking agent can be ulexite.

Examples of suitable zirconium crosslinking agents include, but are not limited to, zirconium ammonium carbonate, zirconium chloride, sodium zirconium lactate, zirconium oxyacetate, zirconium acetate, zirconium oxynitrate, zirconium sulfate, tetrabutoxyzirconium, zirconium monoacetyl acetonate, zirconium (IV) acetyl acetonate, zirconium normal butyrate, zirconium normal propylate, zirconium glycolate, zirconium lactate triethanolamine, zirconium-alkanolamine complexes, borozirconate-alkanolamine complexes, zirconium-hydroxyalkylethylene diamine complexes, water-soluble zirconium chelatea, TYZOR TEAZ organic zirconate and the like. The zirconium crosslinking agent can include at least one component that is a zirconium metal ion.

Examples of suitable titanium crosslinking agents include, but are not limited to, titanium-alkanolamine complexes, borotitinate-alkanolamine complexes, organotitanates, titanium lactate, titanium malate, titanium citrate, titanium ammonium lactate, titanium acetylacetonate, triethanolamine titanate, magnesium titanate, titanium dioxide, other titanate salts, and the like. The titanium crosslinking agent can include at least one component that is a titanium metal ion.

Examples of suitable aluminum crosslinking agents include, but are not limited to, sodium aluminate, aluminum chloride, aluminum bromide, aluminum fluoride, aluminum iodide, aluminum carbide, aluminum ethoxide, aluminum isopropoxide, aluminum stearate, aluminum oxide, aluminum phosphate, bauxite (containing aluminum hydroxide, (e.g., gibbsite), boehmite, kaolinite and/or diaspore), various aluminosilicates, aluminum lactate, aluminum acetate, aluminum citrate, aluminum chlorohydrate, aluminum chloride hexahydrate, aluminum acetyl acetonate, ammonium aluminum sulfate, aluminum metal and combinations thereof.

The crosslinking agent can be present in the aqueous emulsion in various amounts. In some embodiments, the aqueous emulsion can comprise at least 10% by weight (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, or at least 75% by weight) crosslinking agent, based on the total weight of the aqueous emulsion. In some embodiments, the aqueous emulsion can comprise 80% by weight or less (e.g., 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, or 15% by weight or less) crosslinking agent, based on the total weight of the aqueous emulsion.

The amount of crosslinking agent in the aqueous emulsion can range from any of the minimum values described above to any of the maximum values described above. For example, the aqueous emulsion can comprise from 10% by weight to 80% by weight crosslinking agent (e.g., from 20% by weight to 60% by weight crosslinking agent, or from 30% by weight to 50% by weight crosslinking agent), based on the total weight of the aqueous emulsion.

Examples of suitable emulsifying agents include, for example, surfactants, sulfonated hydrocarbons, ethyoxylated nonylphenols, alkali-metal fatty-acid soaps, lignosulfonate, lignite and lignin at high pH, clays, starch, carboxymethylcellulose, fatty acids, and polyaminated fatty acids. In some embodiments, the emulsifying agent can be a surfactant, such as an amphoteric surfactant, anionic surfactant, cationic surfactant, nonionic surfactant, zwitterionic surfactant, or a combination thereof. In certain embodiments, the emulsifying agent can comprise a blend of two or more surfactants (e.g., a blend of two or more nonionic surfactants, a blend of two or more anionic surfactants, or a blend of one or more anionic surfactants and one or more nonionic surfactants).

A wide variety of surfactants are conventionally used, and are known to those skilled in the art. By way of example, the nonionic surfactant can be any type of nonionic surfactant including, but not limited to, glycerol mono oleate, glycerol mono stearate, sorbital mono oleate, diethylene glycol monostearate, propylene glycol mono oleate, sorbitan esters, polysorbates, polyoxyethylene alcohol, alkylphenol ethoxylate, propylene oxide-modified polymethylsiloxane, secondary alcohol ethoxylate, capped alcohol ethoxylate, polyalkoxylated glycol, polyethoxylated glycol, amine oxides, ethoxylated or propoxylated nonyl phenols, ethoxylated or propoxylated alkyl phenols, ethoxylated or propoxylated octyl phenols, ethoxylated or propoxylated dodecyl phenols, ethoxylated or propoxylated primary linear alcohols from C₄ to C₂₀, polyethylene glycols of all molecular weights, polypropylene glycols of all molecular weights, and mixtures thereof. Suitable cationic surfactants include those having a single cationic group which may be of any charge state (e.g., the cationic group may have a single positive charge or two positive charges), such as N,N,N trimethyl-1-octadecammonium chloride: N,N,N trimethyl-1-hexadecammonium chloride, N,N,N trimethyl-1-soyaammonium chloride, and mixtures thereof. Suitable amphoteric surfactants include those containing a single cationic group, such as one or more of glycinates, amphoacetates, propionates, betaines and mixtures thereof. Suitable anionic surfactants includes sulfonates such as sodium xylene sulfonate and sodium naphthalene sulfonate, phosphonates, ethoxysulfates, alkyl sulfates, alkyl ether sulfates, alkyl ester sulfonates, alpha olefin sulfonates, linear alkyl benzene sulfonates, branched alkyl benzene sulfonates, linear dodecylbenzene sulfonates, branched dodecylbenzene sulfonates, alkyl benzene sulfonic acids, dodecylbenzene sulfonic acid, sulfosuccinates, sulfated alcohols, ethoxylated sulfated alcohols, alcohol sulfonates, ethoxylated and propoxylated alcohol sulfonates, alcohol ether sulfates, ethoxylated alcohol ether sulfates, propoxylated alcohol sulfonates, sulfated nonyl phenols, ethoxylated and propoxylated sulfated nonyl phenols, sulfated octyl phenols, ethoxylated and propoxylated sulfated octyl phenols, sulfated dodecyl phenols, ethoxylated and propoxylated sulfated dodecyl phenols, and mixtures thereof.

In some embodiments, the surfactant can comprise an anionic surfactant (e.g., an alkylbenzenesulfonate surfactant). In some embodiments, the surfactant can comprise a nonionic surfactant (e.g., an ethoxylated alcohol surfactant).

The emulsifying agent can be present in the aqueous emulsion in various amounts. In some embodiments, the aqueous emulsion can comprise greater than 0% by weight (e.g., at least 1% by weight, at least 2% by weight, at least 3% by weight, at least 4% by weight, at least 5% by weight, at least 6% by weight, at least 7% by weight, at least 8% by weight, or at least 9% by weight) emulsifying agent, based on the total weight of the aqueous emulsion. In some embodiments, the aqueous emulsion can comprise 10% by weight or less (e.g., 9% by weight or less, 8% by weight or less, 7% by weight or less, 6% by weight or less, 5% by weight or less, 4% by weight or less, 3% by weight or less, 2% by weight or less, or 1% by weight or less) emulsifying agent, based on the total weight of the aqueous emulsion.

The amount of emulsifying agent in the aqueous emulsion can range from any of the minimum values described above to any of the maximum values described above. For example, the aqueous emulsion can comprise from greater than 0% by weight to 10% by weight emulsifying agent (e.g., from greater than 0% by weight to 5% by weight emulsifying agent, or from 1% by weight to 5% by weight emulsifying agent), based on the total weight of the aqueous emulsion.

Any vegetable oil that is determined to be safe to humans, animals and the environment can be used in the emulsion. Examples of vegetable oils including, but not limited to, canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil and tea tree oil. In some embodiments, the vegetable oil is canola oil such as high oleic canola oil. In some embodiments, the vegetable oil is castor oil. The vegetable oil can also be a non-hydrogenated vegetable oil, such as a vegetable-based oil that has not undergone a hydrogenation reaction.

The vegetable oil can be present in the aqueous emulsion in various amounts. In some embodiments, the aqueous emulsion can comprise at least 10% by weight (e.g., at least 15% by weight, at least 20% by weight, at least 25% by weight, at least 30% by weight, or at least 35% by weight) vegetable oil, based on the total weight of the aqueous emulsion. In some embodiments, the aqueous emulsion can comprise 40% by weight or less (e.g., 35% by weight or less, 30% by weight or less, 25% by weight or less, 20% by weight or less, or 15% by weight or less) vegetable oil, based on the total weight of the aqueous emulsion.

The amount of vegetable oil in the aqueous emulsion can range from any of the minimum values described above to any of the maximum values described above. For example, the aqueous emulsion can comprise from 10% by weight to 40% by weight vegetable oil (e.g., from 15% by weight to 35% by weight vegetable oil, or from 20% by weight to 30% by weight vegetable oil), based on the total weight of the aqueous emulsion.

If desired for a particular application (e.g., for low-temperature applications), the aqueous emulsion can optionally further comprise a freeze point depressing agent. A freeze point depressing agents are able to lower the temperature at which a fluid freezes to become a solid. Examples of freeze point depressing agents include alcohols, such as, but not limited to methanol, ethanol, isopropanol, ethylene glycol, propylene glycol, glycerol, alkylene glycol, dialkylene glycol, trialkylene glycol, alkylene glycol monoalkyl ether, dialkylene glycol monoalkyl ether, trialkylene glycol monoalkyl ether, ethylene glycol, diethylene glycol, triethylene glycol, dipropylene glycol, tripropylene glycol, 1.3-propanediol, 1,4-butanediol, 1,4-butenediol, thiodiglycol, 2-methyl-1,3-propanediol, pentane-1,2-diol, pentane-1,3-diol pentane-1,4-diol, pentane-1,5-diol, pentane-2,3-diol, pentane-2,4-diol, hexane-1,2-diol, heptane-1,2-diol, 2-methylpentane-2,4-diol, 2-ethylhexane-1,3-diol, C₁ to C₈ monoalkyl ethers, derivatives thereof, and combinations thereof. The freeze point depressing agent can also comprise a salt (e.g., sodium chloride, calcium chloride, or a formate salt such as sodium formate). The freeze point depressing agent can be any of the conventionally used freeze point depressing agents that are known to those skilled in the art.

When present, the freeze point depressing agent can be present in the aqueous emulsion in various amounts. In some embodiments, the aqueous emulsion can comprise at least 5% by weight (e.g., at least 10% by weight, at least 15% by weight, at least 20% by weight, or at least 25% by weight) freeze point depressing agent, based on the total weight of the aqueous emulsion. In some embodiments, the aqueous emulsion can comprise 30% by weight or less (e.g., 25% by weight or less, 20% by weight or less, 15% by weight or less, or 10% by weight or less) freeze point depressing agent, based on the total weight of the aqueous emulsion.

The amount of freeze point depressing agent in the aqueous emulsion can range from any of the minimum values described above to any of the maximum values described above. For example, the aqueous emulsion can comprise from 5% by weight to 30% by weight freeze point depressing agent (e.g., from 5% by weight to 20% by weight freeze point depressing agent, or from 10% by weight to 15% by weight freeze point depressing agent), based on the total weight of the aqueous emulsion.

In some embodiments, the aqueous emulsion can comprise 20% by weight to 60% by weight crosslinking agent; 10% by weight to 40% by weight vegetable oil; 10% by weight to 40% by weight water; greater than 0% by weight to 10% by weight emulsifying agent; and optionally 5% by weight to 30% by weight freeze point depressing agent. In some embodiments, the aqueous emulsion can comprise 20% by weight to 60% by weight crosslinking agent; 10% by weight to 40% by weight vegetable oil; 10% by weight to 40% by weight water; greater than 0% by weight to 10% by weight emulsifying agent; and optionally 5% by weight to 20% by weight freeze point depressing agent. In some embodiments, the aqueous emulsion can comprise 30% by weight to 50% by weight crosslinking agent; 20% by weight to 30% by weight vegetable oil; 15% by weight to 30% by weight water; greater than 0% by weight to 5% by weight emulsifying agent; and optionally 5% by weight to 20% by weight freeze point depressing agent. In certain embodiments, the aqueous emulsion can comprise 30% by weight to 50% by weight crosslinking agent; 20% by weight to 30% by weight vegetable oil; 15% by weight to 30% by weight water; greater than 0% by weight to 5% by weight emulsifying agent; and optionally 10% by weight to 15% by weight freeze point depressing agent.

In some embodiments, the aqueous emulsion composed of 35-45% by weight boron crosslinking agent, greater than 0%-5% by weight emulsifying agent, 25-35% by weight vegetable oil, 5-15% by weight freeze point depressing agent (when present), and 10-30% by weight water.

In some embodiments, the aqueous emulsion is composed of 16.5% by weight water, 27% by weight canola oil (e.g., OLEOCAL® C-104 oil, Lambent Technologies, Gurnee, Ill.), 3% by weight nonionic surfactant (e.g., RHODASURF® L7 surfactant, Solvay SA, Belgium), 0.5% by weight nonionic surfactant (e.g., ANTAROX® L-61 surfactant, Rhodia Inc., Cranbury, N.J.), 1% by weight ethoxylated alcohol surfactant (e.g., TOMA® 23-6.5 surfactant, Air Products and Chemicals, Inc. Allentown, Pa.), 12% by weight propylene glycol, and 40% by weight ulexite. Optionally, up to 45% by weight ulexite is included in the aqueous emulsion such that the formulation contains: 11.5% by weight water, 27% by weight canola oil, 3% by weight nonionic surfactant, 0.5% by weight nonionic surfactant, 1% by weight ethoxylated alcohol surfactant, 12% by weight propylene glycol, and 45% ulexite. Alternatively, 40-45% by weight ulexite, e.g., 40%, 40.5%, 41%, 41.5%, 42%, 42.5%, 43%, 43.5%, 44%, 44.5% or 45% ulexite, can be included in the aqueous emulsion.

In some embodiments, the aqueous emulsion is composed of 28% by weight water, 25.0% by weight castor oil, 1.9% by weight anionic surfactant (e.g., BIO-SOFT® N-411, commercially available from Stepan Company, Northfield, Ill.), 0.1% by weight fumed silica dispersion (e.g., AERODISP® 7330N, commercially available from Evonik Industries, Essen, Germany), and 45% by weight ulexite. Optionally, up to 15% by weight freeze point depressing agent is included in the aqueous emulsion, such that the formulation contains: 13% by weight water, 25.0% by weight castor oil, 1.9% by weight anionic surfactant, 0.1% by weight fumed silica dispersion, 15% by weight freeze point depressing agent (e.g., propylene glycol or ethylene glycol), and 45% by weight ulexite. Alternatively, 5-15% by weight freeze point depressing agent, e.g., 5%, 6%, 7%, 8%, 9%, 10%, 11%, 12%, 13%, 14%, or 15% by weight by freeze point depressing agent, can be included in the aqueous emulsion.

In some embodiments, the aqueous emulsion can comprise less than 5% by weight (e.g., less than 2.5% by weight, or less than 1% by weight) of a petroleum distillate, based on the total weight of the aqueous emulsion. In some embodiments, the aqueous emulsion can be substantially free of petroleum distillates (e.g., the aqueous emulsion can include less than 0.5% by weight petroleum distillates, based on the total weight of the aqueous emulsion).

In some embodiments, the aqueous emulsion can comprise less than 5% by weight (e.g., less than 2.5% by weight, or less than 1% by weight) of a clay, based on the total weight of the aqueous emulsion. In some embodiments, the aqueous emulsion can be substantially free of clays (e.g., the aqueous emulsion can include less than 0.5% by weight clays, based on the total weight of the aqueous emulsion).

The aqueous emulsions described herein can be prepared by any suitable method. Various methods for making water-in-oil emulsions are known. For example, the components of the aqueous emulsion are added together and mixed thoroughly to form a water-in-oil emulsion containing suspended ulexite. Alternatively, the components of the aqueous emulsion can be added sequentially. For example, the vegetable oil and water can be mixed or blended together along with the emulsifying agent. The freeze point depressing agent can then be mixed or blended with the admixture. Lastly, borate, e.g., ulexite, colemanite or boracite, can be added, thereby forming the aqueous emulsion.

In some embodiments, the emulsion can have an ideal useful temperature range of 100° F. to 300° F. (e.g., 100° F., 110° F., 120° F., 130° F., 140° F., 150° F., 160° F., 170° F., 180° F., 190° F., 200° F., 210° F., 220° F., 230° F., 240° F., 250° F., 260° F., 270° F., 280° F., 290° F., or 300° F.). The emulsion can be used at a temperature equal to or less than 100° F. (e.g., 10° F., 15° F., 20° F., 25° F., 30° F., 35° F., 40° F., 45° F., 50° F., 55° F., 60° F., 65° F., 70° F., 75° F., 80° F., 81° F., 82° F., 83° F., 84° F., 85° F., 86° F., 87° F., 88° F., 89° F., 90° F., 91° F., 92° F., 93° F., 94° F., 95° F., 96° F., 97° F., 98° F., 99° F., or 100° F. The emulsion can be used at a temperature range of equal to or greater than 300° F. (e.g., 300° F., 310° F., 320° F., 330° F., 340° F., 350° F., 360° F., 370° F., 380° F., 390° F., 400° F., 410° F., 420° F., 430° F., 440° F., 450° F., or more. Fluids described herein that contain the emulsion can have the same temperature ranges as the emulsion.

The emulsion can be ideally suited in a pH range of 8-12 (e.g., a pH of 8, 9, 10, 11, 12, or a pH ranging between any of these values). The emulsion can be used at a pH range of about 7-14 (e.g., a pH of 7, 8, 9, 10, 11, 12, 13, 14, or a pH ranging between any of these values). In addition, fluids provided herein that contain the emulsion can have the same pH ranges.

The emulsion can have a crosslinking time from instant (e.g., upon forming the emulsion) to about 10 minutes (e.g., a crosslinking time of 0, 1, 2, 3, 4, 5, 6, 7, 8, 9, 10 minutes, or a crosslinking time ranging between any of these values). In some embodiments, the emulsion formulation can be modified to increase the crosslinking time to greater than 10 minutes (e.g., to a crosslinking time of 11, 12, 13, 14, 15, 16, 17, 18, 19, or 20 minutes or more). Fluids containing the emulsion can have the same crosslinking time.

The aqueous emulsion can be used in as a base carrier fluid for a vegetable based borate delayed crosslinking agent. It can also be used in place of standard oil and clay suspensions that are typically used for slurried ulexite crosslinking agents.

In some embodiments, the aqueous emulsion is prepared at a remote location and transported as a stable emulsion to the site of its intended use, such as the site of the petroleum reservoir. At the site of use, the aqueous emulsion can be mixed with water to form a vegetable based borate delayed crosslinking agent.

Fluids Containing an Aqueous Emulsion and a Crosslinkable Organic Polymer

The aqueous emulsions described above can be used to form a fluid containing a crosslinkable organic polymer (e.g., an organic polymer that is capable of increasing the viscosity of a fluid into a gel).

Suitable crosslinkable organic polymers are known in the art. Examples of suitable crosslinkable organic polymers include galactomannan (e.g., gum ghatti, gum karaya, tamarind gum, tragacanth gum, xanthan gum, tara gum, locust bean gum, carrageenan, guar (naturally occurring guar), and guar derivatives (e.g., carboxyalkyl guar derivatives (e.g., carboxymethylguar), hydroxyalkyl guar derivatives (e.g., hydroxypropylguar), double derivatized guars (e.g., carboxymethylhydroxypropylguar) and other guar derivatives); celluloses (e.g., naturally occurring cellulose, cellulose derivatives (e.g., carboxymethylcellulose, methylcellulose, hydroxyethylcellulose, carboxymethylhydroxyethylcellulose, hydroxyethylcellulose), and polyanionic cellulose); other polysaccharides, and combinations thereof. Other non-limiting examples of modified or derivatized guar for use in the formulations described herein include a guar polymer that contains one or more functional groups such as hydroxyl, cis-hydroxyl, carboxylic acids, derivatives of carboxylic acids, sulfate, sulfonate, phosphate, phosphonate, amino, or amide or a guar polymer that contains one or more monosaccharide units selected from the group consisting of galactose, mannose, glucoside, glucose, xylose, arabinose, fructose, glucuronic acid and pyranosyl sulfate.

In some embodiments, the crosslinkable organic polymer can comprise cellulose (e.g., carboxymethylcellulose, hydroxymethylcellulose, polyanionic cellulose, or combinations thereof). In some embodiments, the crosslinkable organic polymer can comprise galactomannan (e.g., guar, such as natural guar, a guar derivative, or a combination thereof).

The fluid can comprise a crosslinkable organic polymer, a crosslinking agent, an emulsifying agent, a vegetable oil, and water. Optionally, the fluid can also include a freeze point depressing agent. The crosslinking agent, emulsifying agent, vegetable oil, and freeze point depressing agent (when present) can be any of those described above with respect to the aqueous emulsion.

In some embodiments, the fluid can be made by mixing an aqueous emulsion described above with a galactomannan-based slurry or a cellulose-based slurry. In a drilling operation, the fluid can be formed in the fluid system, such as in the wellbore or the fractures. For instance, the aqueous emulsion can be pumped into a subterranean formation after the slurry is introduced downhole. Thus, the crosslinking agent of the emulsion is activated when it comes into contact with the slurry in the wellbore. Optionally, an additive can be pumped downhole after the crosslinker.

The galactomannan slurry or cellulose slurry can be a water-based or an oil-based slurry. In some embodiments, the slurry contained partially or fully hydrated guar or cellulose. During hydraulic fracturing, for instance, the guar gum can be fully hydrated with water prior to being pumped downhole into the formation.

In some embodiments, the fluid can be made from 10-30 pounds of guar slurry (e.g., 10, 11, 12, 13, 14, 15, 16, 17, 18, 19, 20, 21, 22, 23, 24, 25, 26, 27, 28, 29, or 30 pounds of guar slurry), 0.5-2.5 gallons of aqueous emulsion (e.g., 0.5, 0.6, 0.7, 0.8, 0.9, 1.0, 1.0, 1.1, 1.2, 1.3, 1.4, 1.5, 1.6, 1.7, 1.8, 1.9, 2.0, 2.1, 2.2, 2.3, 2.4, or 2.5 gallons of aqueous emulsion), and water. In some instance, a fracturing fluid is added to the aqueous emulsion, the guar slurry, or both. An additive can also be added to the resulting fluid. Non-limiting examples of additives are described below.

In some embodiments, the fluid can be made from 10-30 pounds of guar slurry (e.g., 10, 11, 12, 13, 14, 15, 16, 17, 18, 19, 20, 21, 22, 23, 24, 25, 26, 27, 28, 29, or 30 pounds of guar slurry), 0.5-2.5 gallons of aqueous emulsion (e.g., 0.5, 0.6, 0.7, 0.8, 0.9, 1.0, 1.0, 1.1, 1.2, 1.3, 1.4, 1.5, 1.6, 1.7, 1.8, 1.9, 2.0, 2.1, 2.2, 2.3, 2.4, or 2.5 gallons of aqueous emulsion), 0.5-2.5 gallons of breaker (e.g., 0.5, 0.6, 0.7, 0.8, 0.9, 1.0, 1.0, 1.1, 1.2, 1.3, 1.4, 1.5, 1.6, 1.7, 1.8, 1.9, 2.0, 2.1, 2.2, 2.3, 2.4, or 2.5 gallons of breaker), and water.

Fluids Containing an Aqueous Emulsion, a Crosslinkable Organic Polymer, and a Proppant

In certain embodiments, the fluid can further comprise a proppant. In these cases, the fluid can comprise a crosslinkable organic polymer, a crosslinking agent, an emulsifying agent, a proppant, a vegetable oil, and water. Optionally, the fluid can also include a freeze point depressing agent. The crosslinkable organic polymer, crosslinking agent, emulsifying agent, vegetable oil, and freeze point depressing agent (when present) can be any of those described above.

In some embodiments, the fluid can include a guar derivative, such as hydroxypropyl guar and/or a carboxymethylhydroxypropyl guar, a boron crosslinking agent, an emulsifying agent, vegetable oil, water, and a proppant. In some embodiments, the fluid can include a cellulose derivative, such as carboxymethylcellulose, hydroxymethylcellulose or polyanionic cellulose, a crosslinking agent, such as a zirconium crosslinking agent, an aluminum crosslinking agent or a combination thereof, an emulsifying agent, vegetable oil, water, and a proppant.

Suitable proppants are known in the art. Examples of suitable proppants include, but are not limited to, silica, quartz sand, resin-coated sand, glass beads or materials, ceramic beads or material, nut (e.g., walnut, almonds, and the like) shell fragments, seed shell fragments, fruit pit fragments, aluminum pellets, nylon pellets, composite pellets, organic particles, synthetic particles, polymer materials, polytetrafluoroethylene materials, bauxite, aluminum silicate, calcium oxide, iron oxide, titanium dioxide, kyanite, mullite, phenolic resin, diatomaceous earth, styrene, polystyrene, derivatives thereof, and combinations thereof. The proppant can be any of the conventionally used proppants that are known to those skilled in the art.

The proppant-containing fluids described herein can be used in an oilfield or gas field for various drilling applications. For example, they can serve as a hydraulic fracturing fluid, a subsea fluid, a gravel packing fluid, a pipeline pig fluid, a fluid in subterranean oil or gas production, and the like. For instance, in a pigging system, the fluid can be introduced into the pipeline (e.g., fluid line) to aid in the cleaning process.

In some embodiments directed to hydraulic fracturing, the fluid can be generated inside the fluid system of the fracturing process. For example, the fully hydrated crosslinkable polymer (e.g, galactomannan slurry), the aqueous emulsion, water and the proppant are pumped sequentially downhole, thereby forming the fluid in the formation.

Alternatively, the fluid can be made immediately prior to being pumped downhole. For example, the fully hydrated crosslinkable polymer (e.g., galactomannan slurry), the aqueous emulsion, water and the proppant can be added together to more a mixture. Once formed, the mixture can be pumped into the fluid system. The fluid can be introduced into the system such that the crosslinkable polymer remains non-crosslinked and/or the proppant remains in suspension as the fluid contacts the fracture.

Uses of Fluids

The fluids described herein can be used for the recovery of petroleum from a petroleum reservoir. A wellbore can be drilled to the reservoir. The fluids can be pumped into the petroleum reservoir, thereby introducing fractures in a subterranean formation penetrated by the wellbore to the petroleum. The increased viscosity of the fracturing fluid and due to the delayed crosslinking of the crosslinkable polymer (e.g., the galactomannan) by the crosslinking agent (e.g., the borate) and the proppant, the fluids able to increase the length and width of the fractures. Subsequently, petroleum can be recovered from the reservoir.

In other embodiments, the fluids can be used in gravel packing, pipeline pigging, subterranean oil and gas production, subsea oil and gas production, in addition to hydraulic fracturing. The fluids can also be used in other fluid systems found in oil and gas fields.

Additives

Optionally, the aqueous emulsions and/or fluids described herein can further include one or more additives to improve the properties or function of the aqueous emulsion and/or fluid. Suitable additives are known in the art. For example, in some embodiments, the aqueous emulsions and/or fluids described herein can further include a biocide, a stabilizer, a breaker, a corrosion inhibitor, a scale inhibitor, a proppant, a friction reducer, a lubricant, a gel stabilizer, a viscosifier, a emulsifier, a fluid loss control additive, a pH control agent, a surfactant, any compound, chemical or substance that improves the function of the aqueous emulsion and/or fluid, or any combination thereof.

Useful biocides include, but are not limited to, gluteraldehyde, quaternary ammonium chloride, tetrakis hydromethylphosphonium sulfate, tributyl tetradecyl phosphonium chloride, 2-bromo-2-nitro-3-propanediol, 2-bromo-2-nitro-1,3-propanediol, 2,2-dibromo-3-nitrilopropionamide, 2-monobromo-3-nitrilopropionamide, 2-(thiocyanomethylthio) benzothiazole, 5-chloro-2-methyl-4-isothizolin-3-one, dazomet, dodecyl dimethyl ammonium chloride, magnesium chloride, magnesium nitrate, methyl tert-butyl ether, methyl-4-isothiazolin, phenanthrene, sodium dichloro-s-triazinetrione, polycyclic organic matter, polynuclear aromatic hydrocarbons, quaternary amines, amides, aldehydes, brominated propionamide, a mixture of brominated propionamide and brominated glutaronitrile, 2-bromo-3-nitrol, 3-propanediol, derivatives thereof, and combinations thereof. The biocide can be any of the conventionally used biocides that are known to those skilled in the art.

Useful stabilizers include, but are not limited to, choline chloride, tetramethyl ammonium chloride, potassium chloride, sodium chloride, derivatives thereof and a combination thereof. The stabilizer can be any of the conventionally used stabilizers that are known to those skilled in the art.

Useful breakers include, but are not limited to, ammonium persulfate, diammonium peroxidisulfate, calcium chloride, sodium chloride, sodium chloride, sodium bromate, N,N-dimethylformamide, magnesium peroxide, magnesium oxide, chlorous acid, ethylene glycol, copper compounds, derivatives thereof and a combination thereof. The breaker can be any of the conventionally used breakers that are known to those skilled in the art.

Useful corrosion inhibitors, include without limitation, methanol, isopropanol, formic acid, formamide, acetaldehyde, aldehyde, quaternary ammonium salts, N,N-dimethylformamide, ammonium bisulfate, propargyl alcohol, pyridinium, 1-(phenylmethyl)-ethyl pyridinium, 1-(phenylmethyl)-ethylmethyl derivatives, thiourea, poly(oxy-1,2-ethanediyl)-nonylphenyl-hydroxy, 1-(benzyl)quinolinium chloride, acetone, chloromethylnaphtalene quinolone quaternary amine, diammonium phosphate, nickel sulfate, sodium mercaptobenzothiasole, sodium nitrate, thiourea, zinc carbonate, derivatives thereof and combinations thereof. The corrosion inhibitor can be any of the conventionally used corrosion inhibitors that are known to those skilled in the art.

Suitable scale inhibitors include, but are not limited to, polyacrylamide, acrylamide copolymer (e.g., copolymer of acrylamide and sodium acrylate), citric acid, sodium acrylate, sodium polycarboxylate, ethylene glycol, methylene phosphoric acid, phosphonic acid salts, ammonion chloride, derivatives thereof, and combinations thereof. The scale inhibitor can be any of the conventionally used scale inhibitors that are known to those skilled in the art.

Useful proppants, include but are not limited to, silica, quartz sand, resin-coated sand, glass beads or materials, ceramic beads or material, nut (e.g., walnut) shell fragments, aluminum pellets, nylon pellets, organic particles, synthetic particles, polymer materials, polytetrafluoroethylene materials, glass microspheres, sintered bauxite, aluminum silicate, calcium oxide, iron oxide, titanium dioxide, kyanite, mullite, phenolic resin, diatomaceous earth, styrene, polystyrene, derivatives thereof, and combinations thereof. The proppant can be any of the conventionally used proppants that are known to those skilled in the art.

Suitable friction reducers include, but are not limited to, ammonium sulfate, anionic surfactants, polyacrylamide, copolymers of acrylamides, anionic polymer, cationic polymer, latex polymers, synthetic polymers, petroleum distillate, hydrotreated light petroleum distillate, methanol, ethylene glycol, oil-soluble anionic liquids, cationic polyacrylate liquid, cationic friction reducers, anionic friction reducers, derivatives thereof and combinations thereof. The friction reducer can be any of the conventionally used friction reducers that are known to those skilled in the art.

Suitable acids or bases for pH control include, without limitation, sodium bicarbonate, sodium carbonate, potassium carbonate, sodium hydroxide, acetic acid, sodium diacetate, adipic acid, formic acid, fumaric acid, hydrochloric acid, muriatic acid, monosodium phosphate, and the like. The acid can be any of the conventionally used acids that are known to those skilled in the art. The base can be any of the conventionally used bases that are known to those skilled in the art.

Suitable viscosifiers include, without limitation, guar gum, hydroxyethyl guar, hydropropyl guar, carboxymethyl guar carboxymethyl hydropropyl guar, carboxyalkylhydroxy guar, carboxyalkylhydroxyalkyl guar, guar hydroxyalkyltriammonium chloride, cationic functional guars, hydrophobically modified guars, substituted galactomannans, cellulose, hydroxyehtylcellulose, hydroxyalkylcellulose, starch, gelatin, poly(vinyl alcohol), poly(ethylene imine), xanthan, diuran, scleroglucan, high-molecular weight polysaccharides composed of mannose and galactose sugars, synthetic polymers, andy derivatives thereof and combinations thereof. The viscosifier can be any of the conventionally used viscosifiers that are known to those skilled in the art.

Suitable emulsifiers or emulsifying agents are described above. The emulsifier can be any of the conventionally used emulsifiers that are known to those skilled in the art.

Suitable fluid loss control additive include, without limitation, natural gums, benzoid acid flakes, white starch, fine sand, silica flour, finely ground petroleum hydrocarbon resin, diesel, particulate material and combinations thereof. The fluid loss control additive can be any of the conventionally used fluid loss control additives that are known to those skilled in the art

By way of non-limiting illustration, examples of certain embodiments of the present disclosure are given below.

### Examples

The following examples are set forth below to illustrate the methods and results according to the disclosed subject matter. These examples are not intended to be inclusive of all aspects of the subject matter disclosed herein, but rather to illustrate representative compositions, methods, and results. These examples are not intended to exclude equivalents and variations which are apparent to one skilled in the art.

Efforts have been made to ensure accuracy with respect to numbers (e.g., amounts, temperature, etc.) but some errors and deviations should be accounted for. Unless indicated otherwise, parts are parts by weight, percents are percents by weight based on the total weigh of the composition to which the component is being added, temperature is in ° C. or is at ambient temperature, and pressure is at or near atmospheric. There are numerous variations and combinations of reaction conditions (e.g., component concentrations, temperatures, pressures and other reaction ranges and conditions) that can be used to optimize the product purity and yield obtained from the described process

Example vegetable oil-based boron crosslinkers including ulexite suspended in an aqueous emulsion were prepared. The crosslinkers include a vegetable oil-based carrier fluid (e.g, an aqueous emulsion formed from water and a vegetable oil), one or more surfactants, and a soluble borate (e.g., ulexite). These examples also demonstrate the crosslinking properties of these crosslinkers on guar. The results demonstrate that vegetable oil-based crosslinkers are an environmentally acceptable product that can be use in various drilling operations.

### Example 1. Formulations Including Canola Oil and a Soluble Borate

A vegetable oil-based boron crosslinker was prepared using canola oil. The crosslinker was formulated as follows: 16.5% water, 27% canola oil (e.g., OLEOCAL® C-104 canola oil, commercially available from Lambent Technologies, Gurnee, Ill.), 3% non-ionic surfactant (e.g., RHODASURF® L7 surfactant, commercially available from Solvay SA, Belgium), 0.5% non-ionic surfactant (e.g., ANTAROX® L-61 surfactant, commercially available from Rhodia Inc., Cranbury, N.J.), 1% ethoxylated alcohol surfactant (e.g., TOMA® 23-6.5 surfactant, commercially available from Air Products and Chemicals, Inc. Allentown, Pa.), 12% propylene glycol, and 40% ulexite. The ulexite solids were suspended in the water-in-oil emulsion by standard methods known in the art, such as thorough mixing and blending.

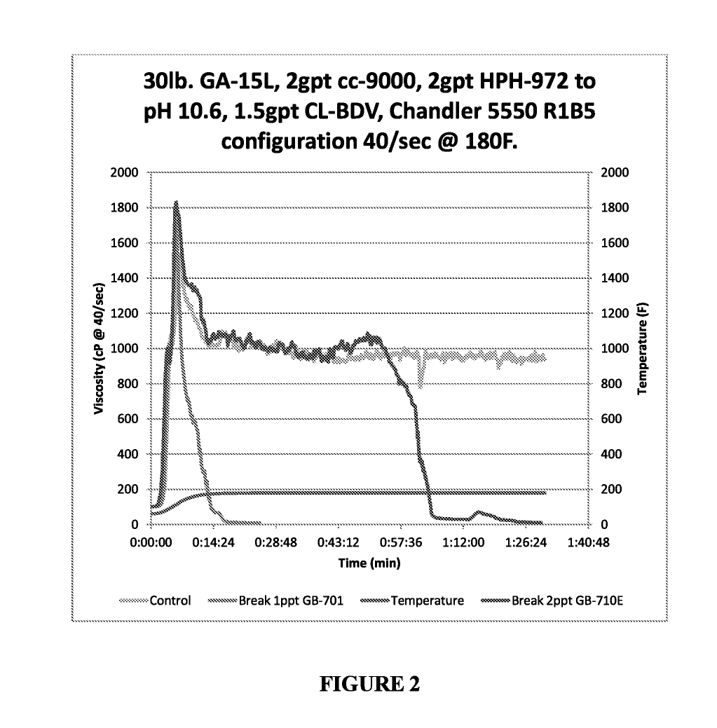

To test the crosslinking properties of the formulation, the crosslinker was added to a water-based hydraulic fracturing fluid containing a guar gum slurry. In particular, 1.5 gallons per ton (gpt) of the crosslinker was mixed with a guar gum slurry containing 30 pounds of guar gum slurry (e.g., FRAC-IT® GA-15L Standard Linear Guar Slurry, commercially available from Frac-Chem, Lafayette, La.), tap water from Lafayette, La., 2 gpt of CC-9000 (choline chloride) and, in the case of FIG. 2, a high pH breaker (e.g., ammonium persulfate (GB 701) or encapsulated ammonium persulfate (GB 710 E)) adjusted to a pH of 10.6. The viscosity of the resulting crosslinker-guar mixture was measured using a Chandler 5550 HPHT rheometer (viscometer) fitted with a B5X bob and R1 rotor. The rotor speed was set at 47 rpm and the temperature was increased to 180° F.

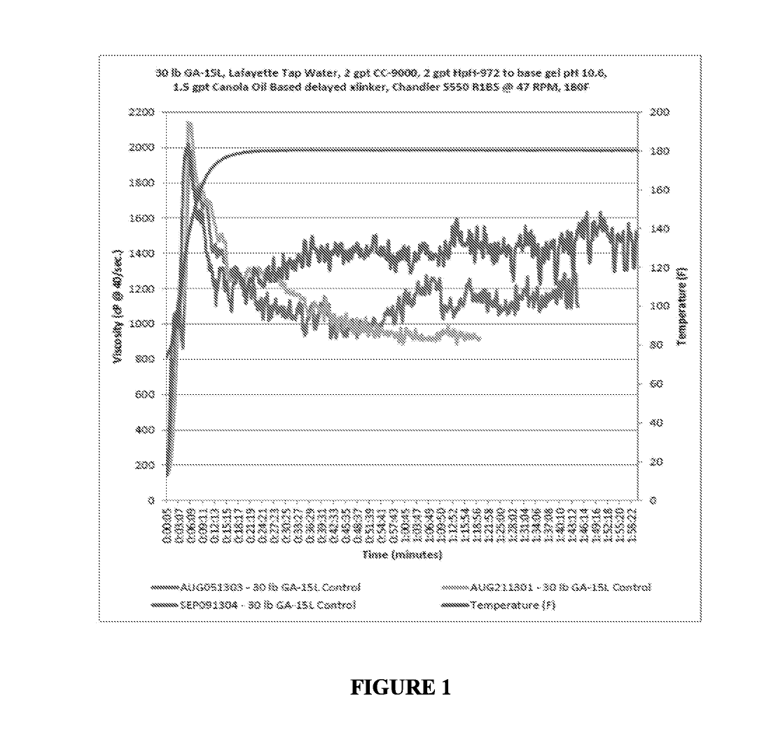

Analysis demonstrated that the ulexite crosslinker was well (evenly) dispersed in the water-based fluid and the crosslinked (gelled) fluid (data not shown). The viscosity of four crosslinker-guar mixtures was tested. The viscosity performance as depicted in the graphs in FIGS. 1 and 2 illustrates that the boron crosslinker formulation effectively crosslinked the guar. In particular, the data shows that the crosslinker initiated crosslinking in about 2 to 3 minutes after the crosslinker-guar mixture was formed.

These experiments demonstrate that the water-in-oil emulsion and oil-in-water emulsions described herein was stable enough to suspend 40%-45% ulexite mineral ore. In addition, the emulsion could serve as a base carrier fluid for the boron crosslinker. The ulexite crosslinker was well (evenly) dispersed in the gelled and water-based fracturing fluids. The crosslinker displayed a similar viscosity performance as currently available delayed crosslinkers.

### Example 2. Formulations Including Castor Oil and a Soluble Borate

A vegetable oil-based boron crosslinker was prepared using castor oil. The crosslinker was formulated as follows: 28.0% water, 25.0% castor oil, 1.9% anionic surfactant (e.g., BIO-SOFT® N-411, commercially available from Stepan Company, Northfield, Ill.), 0.1% fumed silica dispersion (e.g., AERODISP® 7330N, commercially available from Evonik Industries, Essen, Germany), and 45% ulexite. The ulexite solids were suspended in the water-in-oil emulsion by standard methods known in the art, such as thorough mixing and blending.

The crosslinker was added to a water-based hydraulic fracturing fluid containing a guar gum slurry, as described above. As described above, the ulexite crosslinker was well (evenly) dispersed in the gelled and water-based fracturing fluids. The crosslinker displayed a similar viscosity performance as currently available delayed crosslinkers. However, the crosslinker offers many advantages over existing commercially available delayed crosslinkers. For example, the crosslinker is substantially free from classical suspending agents (e.g., clay) as well as petroleum distillates. The product can also be washed from equipment with water, eliminating the need to rinse equipment and lines with an organic solvent such as diesel or mineral oil. As a result, the crosslinkers are more environmentally friendly than existing commercially available delayed crosslinkers.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and methods steps disclosed herein are specifically described, other combinations of the compositions and methods steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of and” consisting of can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1.-69.

70. An aqueous emulsion comprising a crosslinking agent, an emulsifying agent, a vegetable oil, water, and an optional freeze point depressing agent, wherein
said crosslinking agent is selected from the group consisting of a boron crosslinking agent, a zirconium crosslinking agent, a titanium crosslinking agent, an aluminum crosslinking agent, and any combination thereof;
said emulsifying agent comprising at least a surfactant selected from the group consisting of sulfonate surfactant, ethoxylated alcohol surfactant, and any combination thereof;
said vegetable oil comprises at least a non-hydrogenated vegetable oil selected from the group consisting of canola oil, coconut oil, cottonseed oil, olive oil, palm oil, peanut oil, rapeseed oil, safflower oil, sesame oil, soybean oil, sunflower oil, rice bran oil, corn oil, hemp oil, castor oil, almond oil, arachis oil, maize oil, linseed oil, caraway oil, rosemary oil, peppermint oil, eucalyptus oil, coriander oil, lavender oil, citronella oil, juniper oil, lemon oil, orange oil, clary sage oil, nutmeg oil, tea tree oil, and any combination thereof; and
said optional freeze point depressing agent is selected from the group consisting of methanol, ethanol, isopropanol, ethylene glycol, propylene glycol, glycerol, and any combinations thereof.

71. The aqueous emulsion of claim 70, wherein said boron crosslinking agent is selected from the group consisting of ulexite, colemanite, boracite, and any combinations thereof.

72. The aqueous emulsion of claim 71, wherein said boron crosslinking agent comprises ulexite.

73. The aqueous emulsion of claim 70, wherein said sulfonate surfactant is selected from the group consisting of sodium xylene sulfonate, sodium naphthalene sulfonate, alkyl ester sulfonates, alpha olefin sulfonates, linear alkyl benzene sulfonates, branched alkyl benzene sulfonates, linear dodecylbenzene sulfonates, branched dodecylbenzene sulfonates, alkyl benzene sulfonic acids, dodecylbenzene sulfonic acid, sulfosuccinates, sulfated alcohols, ethoxylated sulfated alcohols, alcohol sulfonates, ethoxylated and propoxylated alcohol sulfonates, alcohol ether sulfates, ethoxylated alcohol ether sulfates, propoxylated alcohol sulfonates, sulfated nonyl phenols, ethoxylated and propoxylated sulfated nonyl phenols, sulfated octyl phenols, ethoxylated and propoxylated sulfated octyl phenols, sulfated dodecyl phenols, ethoxylated and propoxylated sulfated dodecyl phenols, and any combination thereof.

74. The aqueous emulsion of claim 73, wherein said sulfonate surfactant comprises a linear alkyl benzene sulfonate or a branched alkyl benzene sulfonate.

75. The aqueous emulsion of claim 74, wherein said linear alkyl benzene sulfonate or branched alkyl benzene sulfonate comprises linear dodecylbenzene sulfonate or branched dodecylbenzene sulfonate.

76. The aqueous emulsion of claim 75, wherein said linear dodecylbenzene sulfonate or branched dodecylbenzene sulfonate comprises linear isopropylamine dodecylbenzenesulfonate or branched isopropylamine dodecylbenzenesulfonate.

77. The aqueous emulsion of claim 70, wherein said emulsifying agent comprises ethoxylated alcohol surfactant.

78. The aqueous emulsion of claim 70, wherein said vegetable oil comprises canola oil or castor oil.

79. The aqueous emulsion of claim 70, wherein said optional freeze point depressing agent comprises propylene glycol.

80. The aqueous emulsion of claim 70, further comprising fumed silica.

81. The aqueous emulsion of claim 70, comprising 20% by weight to 60% by weight crosslinking agent; 10% by weight to 40% by weight vegetable oil; 10% by weight to 40% by weight water; greater than 0% by weight to 10% by weight emulsifying agent; and optionally 5% by weight to 30% by weight freeze point depressing agent.

82. A fluid comprising the aqueous emulsion of claim 70 and a crosslinkable organic polymer comprises galactomannan, cellulose, or any combination thereof.

83. The fluid of claim 82, wherein said cellulose is selected from the group consisting of carboxymethylcellulose, hydroxymethylcellulose, polyanionic cellulose, and any combinations thereof.

84. The fluid of claim 82, wherein said galactomannan comprises a natural guar or a guar derivative.

85. The fluid of claim 82, further comprising an additive selected from the group consisting of a biocide, a clay stabilizer, a breaker, a corrosion inhibitor, a scale inhibitor, a proppant, a friction reducer, a lubricant, a gel stabilizer, a viscosifier, a emulsifier, a fluid loss control additive, a pH control agent, a surfactant, and combinations thereof, wherein
said biocide is selected from the group consisting of gluteraldehyde, quaternary ammonium chloride, tetrakis hydromethylphosphonium sulfate, tributyl tetradecyl phosphonium chloride, 2-bromo-2-nitro-3-propanediol, 2-bromo-2-nitro-1,3-propanediol, 2,2-dibromo-3-nitrilopropionamide, 2-monobromo-3-nitrilopropionamide, 2-(thiocyanomethylthio) benzothiazole, 5-chloro-2-methyl-4-isothizolin-3-one, dazomet, dodecyl dimethyl ammonium chloride, magnesium chloride, magnesium nitrate, methyl tert-butyl ether, methyl-4-isothiazolin, phenanthrene, sodium dichloro-s-triazinetrione, derivatives thereof, and any combinations thereof;
said clay stabilizer is selected from the group consisting of choline chloride, tetramethyl ammonium chloride, potassium chloride, sodium chloride, derivatives thereof, and any combinations thereof;
said breaker is selected from the group consisting of ammonium persulfate, diammonium peroxidisulfate, calcium chloride, sodium chloride, sodium chlorite, sodium bromate, N,N-dimethylformamide, magnesium peroxide, magnesium oxide, chlorous acid, ethylene glycol, copper compounds, derivatives thereof, and combinations thereof;
said corrosion inhibitor is selected from the group consisting of isopropanol, methanol, formic acid, acetaldehyde, aldehyde, quaternary ammonium salts, N,N-dimethyl formamide, ammonium bisulfate, derivatives thereof, and combinations thereof;
said scale inhibitor is selected from the group consisting of polyacrylamide, acrylamide copolymer, sodium acrylate, sodium polycarboxylate, ethylene glycol, methylene phosphoric acid, phosphonic acid salts, derivatives thereof, and combinations thereof; and
said friction reducer is selected from the group consisting of ammonium sulfate, anionic surfactants, polyacrylamide, anionic polymer, cationic polymer, petroleum distillate, hydrotreated light petroleum distillate, methanol, ethylene glycol, derivatives thereof and a combination thereof.

86. A method of recovering petroleum from a petroleum reservoir, the method comprising: (i) pumping the fluid of claim 82 into a petroleum reservoir; and (ii) hydraulically fracturing the petroleum reservoir using the fluid, thereby recovering petroleum from said petroleum reservoir, wherein said a petroleum comprises oil, gas, or a combination thereof.

87. The method of claim 86, further comprising drilling a wellbore to the petroleum reservoir prior to step (ii).
